(19) United States
(12) Patent Application Publication
(10) Pub. No.: US 2020/0039865 A1
(43) Pub. Date: Feb. 6, 2020

(54) THERMAL BENDING DEVICE AND GLASS THERMAL BENDING MOLDING METHOD

(71) Applicant: AAC Technologies Pte. Ltd., Singapore City (SG)

(72) Inventors: Yuqin Yuan, Shenzhen (CN); Bo Xu, Shenzhen (CN); Wei Su, Shenzhen (CN)

(21) Appl. No.: 16/527,041

(22) Filed: Jul. 31, 2019

(30) Foreign Application Priority Data
Aug. 3, 2018 (CN) 201810879240.1

(51) Int. Cl. C03B 23/03

(52) U.S. Cl. CPC C03B 23/0305; C03B 23/0307

(57) ABSTRACT

The present disclosure a thermal bending device comprising an upper mold and a lower mold opposite to the upper mold, the upper mold comprising an upper die and an upper mold plate pressing the upper die, the lower mold comprising a lower die and a lower mold plate abutting against the lower die, characterized in that, the thermal bending device further comprises a first force applying device for driving the upper mold plate to move towards the lower mold plate so as to close the upper mold and the lower mold, a prepressing block for forming a tight press fit with the lower die before closing the upper mold and the lower mold, a second force applying device for driving the prepressing block to move towards the lower mold plate relative to the upper die so as to form a tight press fit with the lower die.

### FIELD OF THE DISCLOSURE

The invention relates to the technical field of thermal bending machines, in particular to a thermal bending device and a glass thermal bending molding method.

### DESCRIPTION OF RELATED ART

The existing glass mold is formed by an upper die and a lower die for thermal bending. As the forming temperature of a glass product is higher and the forming time of the glass product is longer, the existing thermal bending machine is generally divided into a plurality of stations for continuous processing, generally comprising a heating station, a pressurizing station and a cooling station. During the processing of a glass product, the glass product is firstly placed in a mold, and then the mold is placed in the heating station for heating, so that the temperature of the mold and the glass gradually rises from a room temperature to a glass softening temperature; then, the mold is placed in a pressurizing station, and a pressing rod of the thermal bending machine moves downwards to drive an upper mold plate to move downwards, so that an upper mold and an lower mold are closed; finally, the mold is placed in a cooling station to cool the mold so that the temperature of the mold and the glass gradually decreases from the glass softening temperature to the room temperature.

The inventors have found that there are at least the following problems in the prior art: only one pressing rod in each station of the thermal bending machine gives a downward pressing force to the upper mold plate, that is, only the upper die will be subjected to the pressure of the upper mold plate. If the bending of the curved glass side is large, in order to make the bending of the curved glass side meet the requirements, in the mold closing process, greater pressure will be applied to the upper die, so that the overall shape of the glass will undergo greater deformation. Finally, the mold will flatten the deformed large surface, resulting in poor molding quality of the glass surface. In addition, too large deformation of the glass in the mold closing process will easily lead to difficulty or even failure in positioning the glass and reduce the production efficiency of the glass.

Therefore, it is desired to provide new and improvement a thermal bending device and a glass thermal bending molding method to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a sectional view of a thermal bending device provided by the present invention; and

FIG. 2 is another sectional view of the thermal bending device provided by the present invention.

### DETAILED DESCRIPTION

The present disclosure will be hereinafter described in detail below with reference to the attached drawings and embodiments thereof.

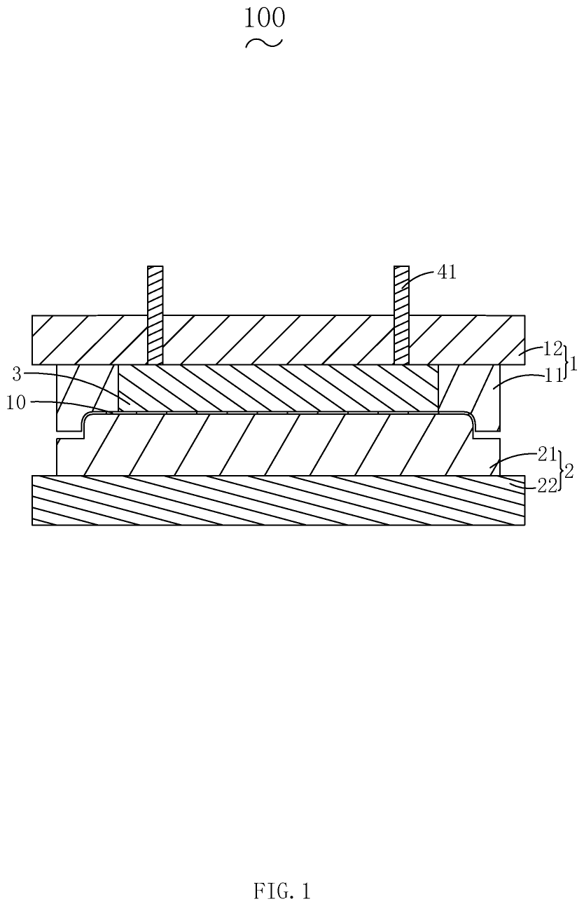

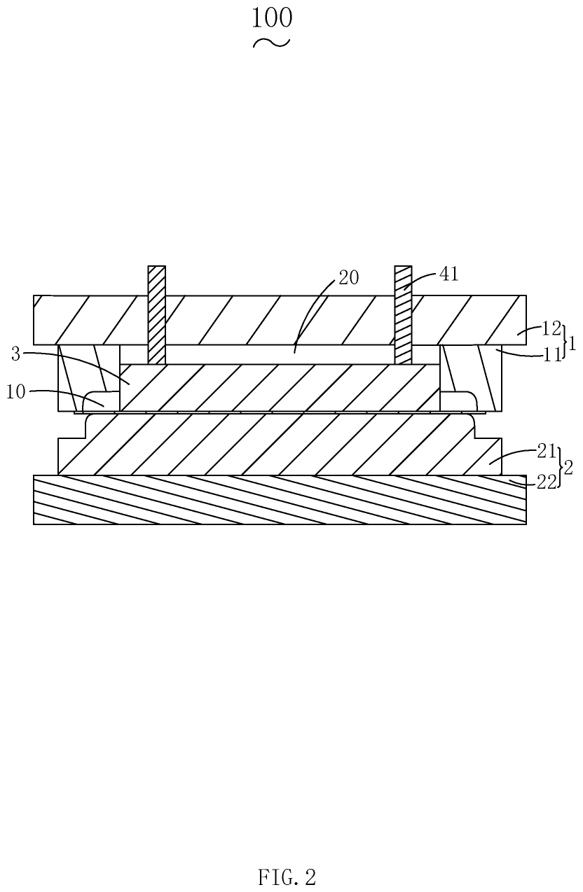

The present invention relates to a thermal bending device 100, as shown in FIGS. 1 and 2.

The thermal bending device 100 comprises an upper mold 1 and a lower mold 2 opposite to the upper mold 1, wherein the upper mold 1 comprises an upper die 11 and an upper mold plate 12 pressing the upper die 11, and the lower mold 2 comprises a lower die 21 and a lower mold plate 22 abutting against the lower die 21. The thermal bending device 100 further includes a first force applying device (not shown) that drives the upper mold plate 12 to move toward the lower mold plate 22 to close the upper mold 1 and the lower mold 2, a prepressing block 3 that forms a tight press fit with the lower die 21 before closing the upper mold 1 and the lower mold 2, and a second force applying device (not shown) that drives the prepressing block 3 to move toward the lower mold plate 22 relative to the upper die 11 to form a tight press fit with the lower die 21. The upper die 11, the lower die 21 and the prepressing block 3 jointly enclose a cavity 10. The first force applying device is abutted against the upper mold plate 12, the prepressing block 3 is accommodated in the upper die 11. The second force applying device is abutted against the prepressing block 3.

The present invention also provides a glass thermal bending molding method, which comprises the following steps:

providing an upper mold 1, a lower mold 2 and a piece of glass to be thermal bent, wherein the upper mold 1 is provided with a prepressing block 3 which can move relative to the upper mold 1;

placing the glass to be thermal bent on the lower mold 2;

The prepressing block 3 of the upper mold 1 firstly presses the glass to be thermal bent onto the lower mold 2, and then the upper mold 1 and the lower mold 2 are closed and pressed together to form a shape of the glass.

Compared with the prior art, the present invention provides the first force applying device for driving the upper mold plate 12 to move towards the lower mold plate 22 to close the upper mold 1 and the lower mold 2, and the second force applying device for driving the prepressing block 3 to move towards the lower mold plate 22 relative to the upper die 11 to form a tight press fit between the prepressing block 3 and the lower die 21, so that in the working process of the thermal bending device 100, in addition to the pressure subjected by the upper die 11 from the upper mold plate to press the glass, the prepressing block 3 is also subjected to pressure from the second force applying device to press the glass, so that the glass can be subjected to the action of forces in multiple directions during processing, thus effectively avoiding the situation that “when a large force in a single direction is applied to the upper die 11 to press the glass, the overall shape of the glass will be greatly deformed, and finally the deformed large surface will be flattened by the mold, resulting in poor molding quality of the glass surface”, thus improving the molding quality of the glass surface, preventing the situation that the positioning of the glass is difficult or even failed due to excessive deformation of the glass, avoiding the need to spend too much time positioning the glass, and improving the production efficiency of the glass. In short, the prepressing block 3 presses the large surface of the glass, and then the upper mold 1 and the lower mold 2 are closed to define the shape of the glass.

Specifically, the second force applying device includes an abutting portion 41 abutting against the prepressing block 3, and a power mechanism (not shown) connected to the abutting portion 41. The power mechanism drives the abutting portion 41 to abut against the prepressing block 3 and move the prepressing block 3 toward the lower mold plate 22. It can be understood that in this embodiment, the abutting portion 41 can be any one or more of an ejector pin, an ejector rod and an ejector plate, and the power mechanism can be any one or more of an air cylinder, a hydraulic cylinder and a motor screw. Different multiple pressing structures such as the ejector rod, the ejector rod and the ejector plate can use the same power mechanism to provide pressure, or different power mechanisms can be used to provide independent pressing force respectively. It is worth mentioning that, as shown in FIG. 2, taking the abutting portion 41 being an ejector rod as an example, the thermal bending device 100 can independently control the pressing time and the pressing force of the ejector rod and the upper mold plate 12, and the pressing force can be set to vary with time. For example, the pressing force of the ejector rod presses down the prepressing block 3 of the mold first, and then the pressing force of the upper mold plate 12 acts on the upper die 11 to thermally bend and mold the side of the glass. The thermal bending device 100 capable of independently controlling multiple times of pressing can design diversified molds according to different shapes of glass, thus improving the flexibility of mold design.

Preferably, the abutting portion 41 penetrates through the upper mold plate 12. This enables the abutting portion 41 to directly abut against the prepressing block 3 without relying on other structures, simplifying the structure of the thermal bending device 100.

It should be noted that the upper die 11 includes a through hole 20 located at a central position, and the prepressing block 3 is accommodated in the through hole 20. The thermal bending device 100 with this structure is simple to manufacture, and no additional structure is required to form a tight press fit between the prepressing block 3 and the lower die 21.

It is worth mentioning that there are a plurality of abutting portions 41, and the plurality of abutting portions 41 are symmetrically arranged at both sides of the central axis of the through hole 20. By arranging a plurality of abutting portions 41, and the plurality of abutting portions 41 are symmetrically arranged at both sides of the central axis of the through hole 20, the upper die 11 is uniformly stressed in the process of pressing the glass, the stability of the thermal bending device 100 is improved, the poor molding quality of the glass surface caused by uneven pressure of the upper die 11 is also avoided, and the molding quality of the glass surface is further improved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A thermal bending device comprising an upper mold and a lower mold opposite to the upper mold, the upper mold comprising an upper die and an upper mold plate pressing the upper die, the lower mold comprising a lower die and a lower mold plate abutting against the lower die, characterized in that, the thermal bending device further comprises a first force applying device for driving the upper mold plate to move towards the lower mold plate so as to close the upper mold and the lower mold, a prepressing block for forming a tight press fit with the lower die before closing the upper mold and the lower mold, a second force applying device for driving the prepressing block to move towards the lower mold plate relative to the upper die so as to form a tight press fit with the lower die, wherein the upper die, the lower die and the prepressing block jointly enclose a cavity, the first force applying device is abutted against the upper mold plate, the prepressing block is accommodated in the upper die and the first force applying device is abutted against the prepressing block.

2. The thermal bending device according to claim 1, characterized in that the second force applying device comprises an abutting portion abutting against the prepressing block and a power mechanism connected with the abutting portion, and the power mechanism drives the abutting portion to abut against the prepressing block and move in a direction towards the lower mold plate.

3. The thermal bending device according to claim 2, characterized in that the abutting portion penetrates through the upper mold plate.

4. The thermal bending device according to claim 3, characterized in that the upper die comprises a through hole located at a central position, and the prepressing block is accommodated in the through hole.

5. The thermal bending device according to claim 4, characterized in that there are a plurality of abutting portions, and the plurality of abutting portions are symmetrically arranged at both sides of the central axis of the through hole.

6. The thermal bending device according to claim 2, characterized in that the abutting portion is any one or more of an ejector pin, an ejector rod and an ejector plate.

7. The thermal bending device according to claim 3, characterized in that the abutting portion is any one or more of an ejector pin, an ejector rod and an ejector plate.

8. The thermal bending device according to claim 4, characterized in that the abutting portion is any one or more of an ejector pin, an ejector rod and an ejector plate.

9. The thermal bending device according to claim 5, characterized in that the abutting portion is any one or more of an ejector pin, an ejector rod and an ejector plate.

10. The thermal bending device according to claim 2, characterized in that the power mechanism is any one or more of an air cylinder, a hydraulic cylinder and a motor screw.

11. The thermal bending device according to claim 3, characterized in that the power mechanism is any one or more of an air cylinder, a hydraulic cylinder and a motor screw.

12. The thermal bending device according to claim 4, characterized in that the power mechanism is any one or more of an air cylinder, a hydraulic cylinder and a motor screw.

13. The thermal bending device according to claim 5, characterized in that the power mechanism is any one or more of an air cylinder, a hydraulic cylinder and a motor screw.

14. A glass thermal bending molding method, characterized in that the method comprises:
providing an upper mold, a lower mold and a piece of glass to be thermal bent, wherein the upper mold is provided with a prepressing block which can move relative to the upper mold;
placing the glass to be thermal bent on the lower mold;
pressing the glass to be thermal bent onto the lower mold by the prepressing block of the upper mold, and then closing the upper mold and the lower mold to form a shape of the glass.
